(19) United States
(12) Patent Application Publication
(10) Pub. No.: US 2024/0100811 A1
(43) Pub. Date: Mar. 28, 2024

(54) CUSHION ASSEMBLY FOR WEARABLE DEVICES

(71) Applicant: Apple Inc., Cupertino, CA (US)

(72) Inventors: Paul X. Wang, Cupertino, CA (US); Adam Y. Kollgaard, Santa Cruz, CA (US)

(21) Appl. No.: 18/456,450

(22) Filed: Aug. 25, 2023

Related U.S. Application Data
(60) Provisional application No. 63/376,750, filed on Sep. 22, 2022.

(51) Int. Cl. B32B 27/06; A42B 7/00; B32B 3/26; B32B 5/02; B32B 5/18; B32B 27/12; B32B 27/28; G06F 1/16

(52) U.S. Cl. CPC B32B 27/065; A42B 7/00; B32B 3/266; B32B 5/02; B32B 5/18; B32B 27/12; B32B 27/283; G06F 1/163; B32B 2307/724; B32B 2307/7376; B32B 2457/20

(57) ABSTRACT

A cushion assembly for a wearable electronic device includes a polymer structure and foam. The polymer structure can include a laminar portion defining a first aperture and a second aperture, a first tube structure extending from a peripheral edge of the first aperture, and a second tube structure extending from a peripheral edge of the second aperture. The foam can be disposed between the first tube structure and the second tube structure.

### CROSS-REFERENCE TO RELATED APPLICATION(S)

This claims priority to U.S. Provisional Patent Application No. 63/376,750, filed 22 Sep. 2022, and entitled “Cushion Assembly for Wearable Devices,” the entire disclosure of which is hereby incorporated by reference.

### FIELD

The described embodiments relate generally to a user contacting cushion assembly of a head-mountable device. More particularly, the present embodiments relate to a user contacting cushion assembly for active user perspiration management.

### BACKGROUND

Recent advances in portable computing have enabled head-mountable devices (HMD) that provide augmented and virtual reality (AR/VR) experiences to users. These head-mountable devices include many components for a user to properly don the head-mountable device, such as a facial engagement feature, padding, bands, securement mechanisms, displays, and other components. Certain portions of these head-mountable devices contact the user's face throughout the duration of use of the head-mountable device. As such, the components in contact with a user's face and head should provide a comfortable and desirable experience. In certain instances while donning a head-mountable device, a user may perform activities that induce perspiration, for example, a physical exercise.

User contacting components of conventional head-mountable devices tend to absorb moisture, creating situations where a user must stop the activity being performed to remove moisture from the user contacting components of the head-mountable device, causing user frustration and interrupting AR/VR related activities. Additionally, user contacting components of the head-mountable display can cause the user contacting component material to degrade, produce an odor, and transmit bacteria between users.

### SUMMARY

In at least one example of the present disclosure, a cushion assembly for a wearable electronic device includes a polymer structure and a foam. The polymer structure can include a laminar portion defining a first aperture and a second aperture, a first tube structure extending from a peripheral edge of the first aperture, and a second tube structure extending from a peripheral edge of the second aperture. The foam can be disposed between the first tube structure and the second tube structure.

In one example, the first tube structure can include a sidewall having a first surface and a second surface opposing the first surface, the first surface defines an empty conduit of the first tube structure, and the second surface defines an outer surface of the first tube structure in contact with the foam. In one example, the foam is disposed against the laminar portion. In one example, the polymer structure includes silicone. In one example, a thickness of the foam is substantially equal to a height of the first tube structure. In one example, the cushion assembly further includes a third aperture defined by the laminar portion, wherein a first distance separating the first aperture from the second aperture is greater than a second distance separating the second aperture from the third aperture. In one example, the polymer structure is molded as a single, unitary piece. In one example, the laminar portion is less than about 100 microns thick.

In at least one example of the present disclosure, an electronic device includes a housing defining a contact surface and a cushion assembly disposed on the contact surface. The cushion assembly can include a polymer structure having a laminar portion defining an aperture, and a tube structure extending from a peripheral edge of the aperture, the tube structure defining a passageway extending through the cushion assembly, and a foam layer disposed against the laminar portion.

In one example, the laminar portion is a first laminar portion and the polymer structure includes a second laminar portion. In one example, the foam layer is disposed between the first laminar portion and the second laminar portion. In one example, the aperture is a first aperture, the second laminar portion defines a second aperture, and the tube structure extends from the first aperture to the second aperture. In one example, the second laminar portion defines a third aperture in fluid communication with the foam layer. In one example, the tube structure is configured to allow air from a first source to pass through the cushion assembly via the first aperture and the second aperture, and the third aperture defined by the second laminar portion, the third aperture defined adjacent to the foam.

In at least one example of the present disclosure, a head mountable device includes a display portion including a display screen, a securement strap connected to the display portion, and a cushion assembly extending from the display portion. The cushion assembly can include a foam layer and a perforated silicone barrier including tube structures extending through the foam layer.

In one example, the head mountable device further includes a textile layer. In such an example, the perforated silicone barrier is disposed between the textile layer and the foam layer. In one example, the perforated silicone barrier defines a set of aperture and each tube structure of the tube structures extending through the foam layer extends from an aperture of the set of apertures. In one example, the perforated silicone barrier is configured to press against a face. In one example, the tubes define passageways through the cushion assembly and through which air can flow. In one example, the apertures of the set of apertures are non-uniformly spaced.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of an example head-mountable device including a cushion assembly;

FIG. 2A shows a front view of an example of a cushion assembly;

FIG. 2B shows a cross-section view of an example of a cushion assembly;

FIG. 3 shows a zoomed perspective view of a portion of an example of a cushion assembly;

FIG. 4 shows a horizontal cross-section of a cushion assembly; and

FIG. 5 shows a portion of an example of a cushion assembly.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to a cushion assembly of a head-mountable device. More particularly, the cushion-assembly of the head-mountable device utilizes a textile foam silicone hybrid for waterproofing, comfort, and breathability.

Conventional head-mountable devices may employ foam or silicone cushion assemblies. Foam cushion assemblies absorb user-generated perspiration, producing an uncomfortable user experience. Over time, perspiration also causes discoloration, odor, or a loss in rigidity of the cushion assembly. Silicone cushion assemblies are waterproof, but lack material breathability, leading to increased perspiration levels during use. Though waterproof, silicone cushion assemblies become slippery as a user perspires, moving from the original user positioned location to a less desirable location while in use. In addition, the cushion assembly of a conventional head-mountable device is uniformly rigid across all locations of the cushion assembly, creating user discomfort and pressure points, creating an inadequate seal around the user's face. The lack of variable rigidity negatively impacts user experience creating a poor AR/VR experience.

In contrast, the head-mountable device of the present disclosure employs a textile foam silicone hybrid cushion assembly that is simultaneously waterproof and breathable. The cushion assembly feature of the head-mountable device is designed to minimize user perspiration and manage user produced perspiration in a comfortable and accommodating way, leading to an improved user experience. The textile foam silicone cushion assembly disclosed herein can also employ variable rigidity through the spacing of breathable tubes to ensure a secure connection with the facial structure of the user and effectively seal the display portion to minimize the perception of external light.

In some examples, the cushion assembly for a wearable electronic device includes a polymer structure, including a laminar portion defining a first aperture and a second aperture, a first tube structure extending from a peripheral edge of the first aperture, and a second tube structure extending from a peripheral edge of the second aperture, and foam disposed between the first tube and the second tube.

In other examples, the electronic device includes a housing defining a contact surface and a cushion assembly disposed on the contact surface. The cushion assembly can include a polymer structure including a laminar portion defining an aperture, a tube extending from a peripheral edge of the aperture, the tube defining a passageway extending through the cushion assembly, and a foam layer disposed against the laminar surface.

In yet other examples, the electronic device can be a head mountable device including a display portion including a display screen, a securement strap connected to the display portion, and a cushion assembly extending from the display portion. The cushion assembly can include a foam layer, and a perforated silicone barrier including tubes extending through the foam layer. The present exemplary systems and methods can be used with any number of head mountable devices including electronic systems intended to be donned and positioned on a user's head, typically with a display directed at a user's eyes.

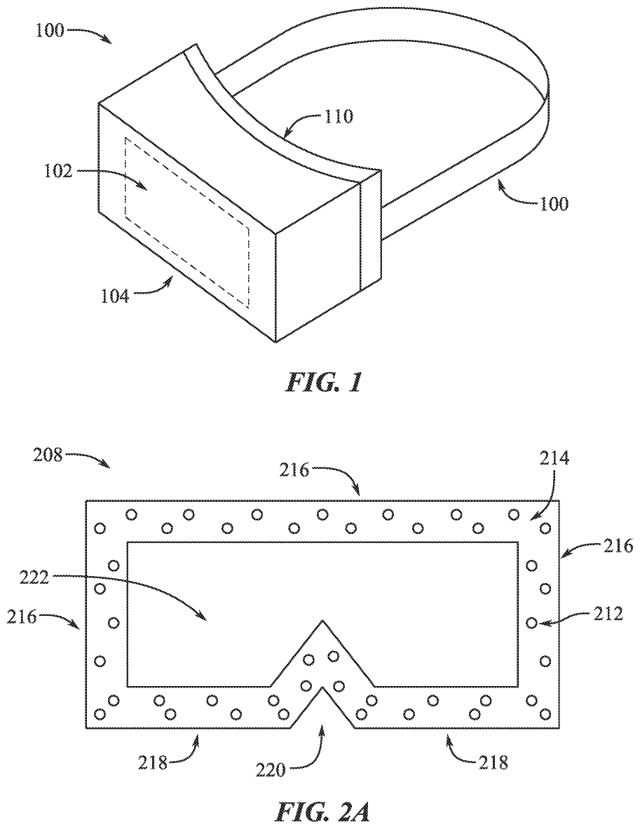

These and other embodiments are discussed below with reference to FIGS. 1-5. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a head-mountable device (HMD) 100. The head-mountable device 100 can include a housing 104 with a display 102 disposed therein, a cushion 110, and a securement strap 106. The display 102 can include one or more optical lenses or display screens configured to be in front of the eyes of a user when the device 100 is donned. The display 102 can include a display screen or display unit for presenting an augmented reality virtualization, a virtual reality virtualization, or other suitable virtualization to a user. Additionally, the display 102 can be positioned in or on the housing 104. In some examples, the housing 104 can support or house a variety of electronic components, including the display, 102.

The cushion 110 can be removably connect to the housing 104, for example at a contact surface of the housing 104, wherein the cushion 110 can be removably connected. As used herein, the terms “cushion,” “facial interface,” “light seal,” “facetrack,” or “engagement interface,” refer to a portion of the head-mountable device 100 that engages (i.e., contacts or conforms to) a user's face. In particular, the cushion 110 can include portions of a head-mountable device that conform or press against regions of a user's face. The cushion 110 can be disposed on a contact surface of the housing 104 pointing in the directions of a user's face and eyes. In some examples, the cushion 208 can include a pliant (or semi-pliant) cushion or lumen that spans the forehead, wraps around the eyes, contacts other regions of the face (e.g., zygoma and maxilla regions), and bridges the nose.

In addition, the cushion 110 can include various components forming a frame, structure, or webbing of the head-mountable device 100 disposed between the display 102 and the user's skin. In some examples, the cushion 110 can include a seal (e.g., an environmental seal, dust seal, air seal, light seal, etc.) It will be appreciated that the term “seal” can include partial seals or inhibitors, in addition to complete seals (e.g., a partial light seal where incoming ambient light is blocked and a complete seal where all ambient light is blocked when the head-mountable device 100 is donned). The cushion can be removably attached to the housing 104 and in electrical communication with the display 102.

In one example, the head-mountable device 100 includes the display portion (e.g., housing 104) including the display 102, the securement strap 106 connected to the display portion (e.g., housing 104), and a cushion assembly 110. The cushion assembly 110 includes a foam layer and a perforated silicon barrier including tubes exiting from the foam layer.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

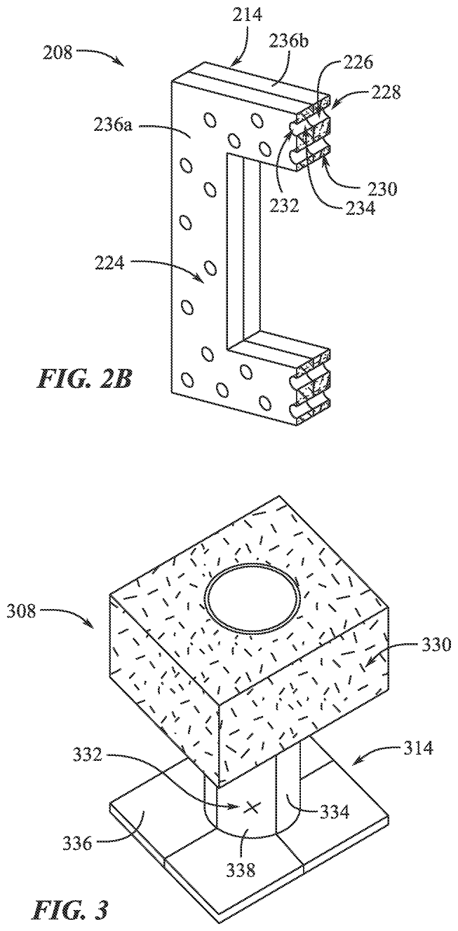

FIG. 2A illustrates a front view of a cushion 208 intended to contact a user's face while donning a head-mountable device, such as the head-mountable device 100 shown in FIG. 1. In one example, the cushion 208 is one continuous piece creating a closed loop 222 and contacting a forehead region 216, a maxilla region 216, a zygomatic region 218 and a nasal region 220 of a user's face. In another example, the cushion 208 includes a polymer structure 214. The polymer structure 214 can include silicone and be molded as a single unitary piece. The term “molded” refers to a mechanical molding process such as injection molding, liquid silicone molding, or vacuum molding, where heat and pressure form a material in a mold creating an intended shape via a mold, such as the cushion 208. One of sufficient skill in the art will appreciate that other materials, or polymers (e.g., thermoplastics, thermosets, or elastomers) may constitute the polymer structure 214 portion of the cushion 208. The cushion 208 includes perforations 212 providing a conduit for wicking moisture. In one example, the moisture wicking function is performed via capillary action.

FIG. 2B shows a perspective cutaway view of the cushion 208 shown in FIG. 2A. In some examples, such as the example shown in FIG. 2B, the polymer structure 214 of the cushion 208 includes a laminar portion 224 defining a first aperture 232 with a first tube structure 234 extending from a peripheral edge of the first aperture 232. The polymer structure 214 can further include a second aperture 228 with a second tube structure 226 extending from a peripheral edge of the second aperture 228. For example, the first and second apertures 232, 228 can meet concentrically, joining the first tube 234 with the second tube 226 such that the tubes 234, 226 form a passageway extending through a foam 230 disposed between the first tube 234 and the second tube 226. This process can be performed through molding, micro-molding, or liquid silicon molding. In some instances, the polymer structure is molded and then perforated, creating small openings. The openings can be positioned and spaced in such a way that the stiffness of the polymer structure 214 can be tuned, varying the rigidity of the polymer structure 214 at specific locations along the cushion 208, for example at the forehead and lateral cheek bone to better accommodate increased load than the nasal bone.

The term “foam” refers to a permeating, lightweight material produced by pushing gas bubbles into a polymer material, making it a type of expanded plastic and/or rubber. The foam material can include closed cell foam, open cell foam, high density foam, high resilience foam, latex foam, memory foam, lux foam, or other types of foam materials incorporated into a head-mountable device.

In some examples, the thickness of the foam 230 is substantially equal to the height of the first tube 234. In another example, the foam 230 can be disposed against the laminar portion 236 of the polymer structure 214. In certain instances, the laminar portion 236 is less than about 100 microns thick, acting as a film or covering to the foam 230 such that the foam 230 is not exposed to the user's line of site.

In another example, the laminar portion 236 of the polymer structure 214 includes a first laminar portion 236a and a second laminar portion 236b with the foam 230 disposed between the first laminar portion 236a and the second laminar portion 236b. The first laminar portion 236a includes the first aperture 232 and the second laminar portion 236b includes the second aperture 228. The first tube 234 extends from the first aperture 232 to the second tube 226, the second tube 226 extending to the first tube 234 from the second aperture 228.

Any of the features, components, and/or parts, including the arrangements and configurations thereof shown in FIGS. 2A-2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2A-2B.

A magnified and exploded perspective view of a portion of a cushion assembly 308, as shown in FIG. 3, illustrates a polymer structure 314 including a laminar portion 336 defining an aperture 332 with a tube 334 extending from a peripheral edge 338 of the aperture 332. The tube 334 defines a passageway extending through the cushion assembly 308. In one example, the polymer structure 314 includes a foam layer 330 disposed against the laminar portion 336.

In one example, the laminar portion 336 is formed from waterproof silicone intended to contact a user's face. The laminar portion 336 includes the aperture 332, allowing fluid (e.g., perspiration from a user) to pass through the aperture 332 and into the tube 332. In some examples, the aperture 332 diameter ranges from 100 microns to about 2 mm or 3 mm. The foam layer 330 of the cushion assembly 308 acts as padding, providing a level of comfort to a user while donning a head-mountable device. Further, the foam layer 330 is protected from fluid by the laminar portion 336 which directs a user's perspiration into the tube 334 providing an empty conduit for fluid, such as a user's perspiration or air, to flow through the foam layer 330 without contacting the foam layer 330.

In at least one example, the foam layer 330 can define an aperture or through-hole through which the tube 334 extends when assembled together with the laminar portion 336. The through-hole of the foam layer 330 can be dimensioned to receive the tube 334 such that the foam layer 330 surrounds the tube 334. In one example, an inner diameter of the through-hole of the foam layer 330 is equal to or greater than the outer diameter of the tube 334 when the foam layer 330 is assembled with the laminar portion 336 such that the tube 334 extends through the through-hole of the foam layer 330. In at least one example, there is no foam or foam portion disposed within the tube when assembled.

In at least one example, the laminar portion 336 is configured to press against the user's face such that according to the orientation of FIG. 3, the user's face or skin is disposed below and against the laminar portion 336. The laminar portion 336 can act as a barrier between the user's face and the foam layer 330 layer. In this way, the moisture from a user's face is drawing through the empty space within the tube 334 and no foam is contacted by the moisture. In this way, the foam remains dray while still providing cushioning to the user.

In at least one example, FIG. 3 illustrates a perspective view of only a portion of a cushion assembly 308. That is, in at least one example, the portion shown in FIG. 3 is one of many repeating portions including a single laminar portion 336 defining multiple apertures and multiple tubes, similar to the tube 334 shown in FIG. 3, extending from respective apertures. In such an example, each tube of the plurality of tubes can be separated from one or more adjacent tubes by a distance. In this way, the cushion assembly 308 can form a sheet or extended surface where multiple tubes provide conduits for drawing perspiration away from a user's face.

Along these lines, in at least one example, FIG. 3 illustrates a perspective view of only a portion of a foam layer 330, which can be repeated to extend between the multiple tubes of a single laminar portion 336 noted above. In this way, the foam layer 330 can be disposed between multiple adjacent tubes of a single cushion assembly 308, with multiple through-holes in the foam layer 330 corresponding in position with the multiple tubes such that respective tubes extend through respective through-holes of the foam layer 330.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

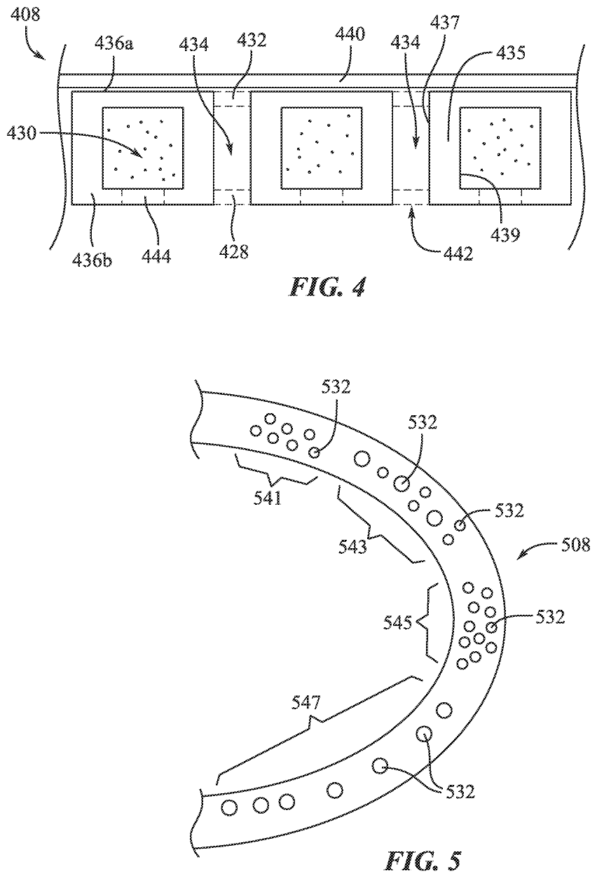

FIG. 4 illustrates a cross-sectional view of an example cushion assembly 408. In one example, the cushion assembly 408 includes a textile layer 440, a perforated polymer barrier, referred to herein as a perforated silicone barrier 442, and a foam layer 430. The textile layer 440 can be optional in some examples to provide comfort to the user, who, when donning the device including the cushion assembly 408, contacts the textile layer 440 with the user's skin. In this way, in at least one example, the textile layer 440 can be disposed between the user's face and the perforated silicone barrier 442 when donning the device. The textile layer 440 can be a woven textile of natural or artificial fibers or a combination thereof. The textile layer 440 can include breathable materials that do not prevent moisture from a user's face from passing through to the tube(s) 434 of the cushion assembly 408. Other materials are also contemplated. The textile layer 440 can include materials that do not retain moisture such that when perspiring, the moisture from the user's face does not build up and remain on or in the textile layer 440.

The perforated silicone barrier 442 includes tubes 434 extending through the foam layer 430. The tube(s) 434 is configured to allow a first air to pass through the cushion assembly 408 via a first aperture 432 and a second aperture 428. The foam layer 430 can be in fluid communication with an external environment beyond the perforated silicone barrier 442 through a third aperture 444 defined by the perforated silicone barrier 442. In this way, the third aperture 444 allows a second air within the pores of the foam layer 430 to pass through a second laminar portion 436b. The third aperture 444 allows the cushion assembly 408 to expand and compress freely, adapting to a user's face and providing a comfortable and customized fit. In addition to adapting to a user's face, the third aperture 444 also provides venting, acting as an outlet for moisture to exit. As moisture exists the foam layer 430, the foam layer 430 is able to dry and prevent the buildup of moisture. In at least one example, the third aperture 444 is defined by the second laminar portion 436b, the third aperture 444 defined adjacent to the foam layer 430.

In one example, the perforated silicone barrier 442 defines a set of apertures 432, 444 with the tube 434 extending from a peripheral edge of an aperture 432 to a set of apertures 428, 444. For example, the tube 434 can extend starting from the first aperture 432 and terminating at the second aperture 428 and adjacent to the third aperture 444. The tube(s) 434 define passageways through the cushion assembly 408 through which air can flow, creating sufficient ventilation to evaporate moisture from the cushion assembly 408. Similarly, the air and enter or exit the cushion assembly 408 through the apertures 434, 428, 444 allowing the cushion to expand or contract according to a user's facial profile.

In at least one example, each tube 434 or a plurality of tubes of the cushion assembly 408 can include a sidewall 435, such as a tubular or hollow cylindrical sidewall, having a first surface 437 and a second surface 437. The first surface can define the conduit or empty space within the tube 434 through which moisture is configured to flow. The second surface 439 opposing the first surface 437 can define an outer surface of the structure of the tube 434 and configured to be in contact with the foam 430 disposed between adjacent tubes 434.

Any of the features, components, and/or parts, including the arrangements and configurations thereof shown in FIG. 4 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

FIG. 5 illustrates the repeatable cell structure of the silicone barrier described in FIG. 4 of a cushion assembly 508 repeated in uniform and non-uniform configurations or spacing. It will be appreciated that the apertures 532 can vary in size, shape or roundness, spacing, location, or other forms of placement on the cushion assembly 508. For example, the number of apertures 532 may increase or decrease depending on a desired rigidity for a specific region of the cushion assembly 508. As noted above with reference to other examples shown in other figures, structural tubes extending through the cushioning assembly 508 can be formed corresponding in position with each aperture 532. An increased density or number of tubes can increase the mechanical properties of the cushioning assembly, including the stiffness and overall cushioning of the assembly 508, and vice versa. In one example, the spacing, positions, size or diameter of the apertures 532 (and therefore each associated tube) may increase or decrease to produce a certain flexibility, feel or comfort level for a user, for example, around a user's eyes or nose may require a smaller diameter or size aperture 532 than at another region of the cushion assembly 508. In a certain configuration, a desired rigidity may be achieved by increasing or decreasing the spacing between the apertures 532 producing a certain stiffness.

In the example shown in FIG. 5, the density of the apertures 532 (and therefore tubes) of the cushioning assembly 508 can vary throughout the assembly 508. This variation can be due to the variation in spacing and size or shape of the aperture 532. This variation can also affect the breathability of the cushioning assembly 508 with more breathability at portions where more apertures, or areas through the cushioning assembly 508, are present or enlarged. In this way, certain portions or areas of the cushioning assembly 508 can be designed to be stiffer than others or be more breathable than others while different areas can be designed to provide more cushioning and less rigidity. It can thus be advantageous to provide stiffer portions areas contacting the face where the cushioning assembly 508 carries more of the weight or load from a device pressed against a user's face while other portions are designed to be more breathable where a user's face is more likely to produce moisture from perspiration.

In at least one example, as shown in FIG. 5, multiple regions of the cushioning assembly 508 can include varying spacing, sizing, and configurations of apertures 532. A first region 541, a second region 543, a third region 545, and a fourth region 547 can be designed with varying arrangements and numbers of apertures 532 as shown. In at least one example, the third region 545 can include apertures 532 that are more tightly packed than apertures from the second region 543. In such an example, the cushion assembly 508 can be stiffer at the third region 545 than at the second region 543. This can be advantageous, for example, where the third region 545 is positioned and configured to press against the nose or forehead of the user where more stiffness may be required to hold the head-mountable display device on the user's face. In another example, the first region 541 can include apertures 532 that are smaller than the apertures 532 of the fourth region 547. In this way, different areas or regions of the cushion assembly 508 can include different mechanical properties as desired.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

In some examples, the present exemplary systems and methods can collect, store, use, and/or transmit personal information data related to users of the systems described herein. Such collection, storage, use and/or transmission can be conducted in order to provide a customized and personalized experience to a user. However, if such collection, storage, use and/or transmission of personal information data is performed, it should be conducted in accordance with standard and well-accepted personal information data procedures and protocols intended to prevent the unauthorized and/or unintentional access to the personal information data. However, the present exemplary systems and methods can be performed without the use of such personal information data.

The detailed description provided above includes specific language and nomenclature in order to provide a thorough understanding of the described embodiments and examples. However, the specific details are not required in order to practice the described embodiments. To the contrary, the foregoing descriptions of the various specific embodiments and configurations described herein are presented for purposes of illustration and description, and are not intended to be exhaustive, comprehensive, or to limit the embodiments to the precise forms disclosed. In fact, many modifications and variations are possible in view of the above teachings.

What is claimed is:

1. A head mountable device, comprising:
a display portion including a display screen;
a securement strap connected to the display portion; and
a cushion assembly extending from the display portion, the cushion assembly comprising:
a foam layer; and
a perforated polymer barrier including tube structures extending through the foam layer.

2. The head mountable device of claim 1, further comprising a textile layer, wherein the perforated polymer barrier is disposed between the textile layer and the foam layer.

3. The head mountable device of claim 1, wherein:
the perforated polymer barrier defines a set of apertures; and
each tube structure of the tube structures extending through the foam layer extends from an aperture of the set of apertures.

4. The head mountable device of claim 3, wherein the perforated polymer barrier is configured to press against a face.

5. The head mountable device of claim 4, wherein the tube structures define passageways through the cushion assembly and through which air can flow.

6. The head mountable device of claim 3, wherein the apertures of the set of apertures are non-uniformly spaced.

7. An electronic device, comprising:
a housing defining a contact surface; and
a cushion assembly disposed on the contact surface, the cushion assembly comprising:
a polymer structure, including:
a laminar portion defining an aperture;
a tube structure extending from a peripheral edge of the aperture, the tube structure defining a passageway extending through the cushion assembly; and
a foam layer disposed against the laminar portion.

8. The electronic device of claim 7, wherein:
the laminar portion is a first laminar portion; and
the polymer structure includes a second laminar portion.

9. The electronic device of claim 8, wherein the foam layer is disposed between the first laminar portion and the second laminar portion.

10. The electronic device of claim 9, wherein:
the aperture is a first aperture;
the second laminar portion defines a second aperture; and
the tube structure extends from the first aperture to the second aperture.

11. The electronic device of claim 10, wherein the second laminar portion defines a third aperture in fluid communication with the foam layer.

12. The electronic device of claim 11, wherein:
the tube structure is configured to allow air to pass through the cushion assembly via the first aperture and the second aperture; and
the third aperture defined by the second laminar portion, the third aperture defined adjacent to the foam.

13. A cushion assembly for a wearable electronic device, the cushion assembly comprising:
a polymer structure, comprising:
a laminar portion defining a first aperture and a second aperture;
a first tube structure extending from a peripheral edge of the first aperture; and
a second tube structure extending from a peripheral edge of the second aperture; and
foam disposed between the first tube structure and the second tube structure.

14. The cushion assembly of claim 13, wherein:
the first tube structure includes a sidewall having a first surface and a second surface opposing the first surface;
the first surface defines an empty conduit of the first tube structure; and
the second surface defines an outer surface of the first tube structure in contact with the foam.

15. The cushion assembly of claim 13, wherein the foam is disposed against the laminar portion.

16. The cushion assembly of claim 13, wherein the polymer structure comprises silicone.

17. The cushion assembly of claim 13, wherein a thickness of the foam is substantially equal to a height of the first tube structure.

18. The cushion assembly of claim 13, further comprising a third aperture defined by the laminar portion, wherein a first distance separating the first aperture from the second aperture is greater than a second distance separating the second aperture from the third aperture.

19. The cushion assembly of claim 13, wherein the polymer structure is molded as a single, unitary piece.

20. The cushion assembly of claim 13, wherein the laminar portion is less than about 100 microns thick.
